(19) United States
(12) Patent Application Publication
(10) Pub. No.: US 2025/0294506 A1
(43) Pub. Date: Sep. 18, 2025

(54) COMMUNICATION DEVICE, COMMUNICATION METHOD, AND NON-TRANSITORY STORAGE MEDIUM

(71) Applicant: TOYOTA JIDOSHA KABUSHIKI KAISHA, Toyota-shi Aichi-ken (JP)

(72) Inventors: Jing MA, Koto-ku Tokyo (JP); Lei ZHONG, Chuo-ku Tokyo (JP); Xiao SHAO, Kawasaki-shi Kanagawa-ken (JP); Takamasa HIGUCHI, Chofu-shi Tokyo (JP)

(73) Assignee: TOYOTA JIDOSHA KABUSHIKI KAISHA, Toyota-shi Aichi-ken (JP)

(21) Appl. No.: 19/049,026

(22) Filed: Feb. 10, 2025

(30) Foreign Application Priority Data
Mar. 12, 2024 (JP) 2024-037805

(51) Int. Cl. H04W 64/00; H04W 24/10; H04W 84/12

(52) U.S. Cl. CPC H04W 64/00; H04W 24/10; H04W 84/12

(57) ABSTRACT

A communication device functioning as a first communication device in a spatial sensing system includes a controller. The controller is configured to transmit a control signal for controlling both spatial sensing using a first measurement signal and spatial sensing using a second measurement signal to a second communication device in a first frequency band. The controller is configured to transmit to the second communication device or receive from the second communication device, the first measurement signal in the first frequency band. The controller is configured to transmit to the second communication device or receive from the second communication device, the second measurement signal in a second frequency band higher than the first frequency band.

### CROSS-REFERENCE TO RELATED APPLICATION

This application claims priority to Japanese Patent Application No. 2024-037805 filed on Mar. 12, 2024, incorporated herein by reference in its entirety.

### BACKGROUND

### 1. Technical Field

The present disclosure relates to a communication device, a communication method, and a non-transitory storage medium.

### 2. Description of Related Art

A technique for sensing a space by utilizing wireless signals in a GHz band has been studied (for example, Jianyuan Yu, et al., Multi-Band Wi-Fi Sensing With Matched Feature Granularity, IEEE Internet of Things Journal, Volume. 9 Issue. 23, Feb. 7, 2022).

### SUMMARY

The present disclosure provides a communication device, a communication method, and a non-transitory storage medium that achieve balance between accuracy and speed of spatial sensing.

A communication device according to a first aspect of the present disclosure functions as a first communication device in a spatial sensing system including the first communication device and a second communication device. The communication device includes a controller. The controller is configured to execute transmitting a control signal for controlling both spatial sensing using a first measurement signal and spatial sensing using a second measurement signal to the second communication device in a first frequency band. The controller is configured to execute transmitting to the second communication device or receiving from the second communication device, the first measurement signal in the first frequency band. The controller is configured to execute transmitting to the second communication device or receiving from the second communication device, the second measurement signal in a second frequency band higher than the first frequency band.

In the communication device according to the first aspect of the present disclosure, the first frequency band may be a frequency band lower than 10 GHz. The second frequency band may be a frequency band equal to or higher than 10 GHz.

In the communication device according to the first aspect of the present disclosure, the controller may be configured to transmit the control signal to the second communication device prior to transmission or reception of the first measurement signal and the second measurement signal.

In the communication device according to the first aspect of the present disclosure, the control signal may be a signal that transmits both a parameter related to the spatial sensing using the first measurement signal and a parameter related to the spatial sensing using the second measurement signal, to the second communication device.

In the communication device according to the first aspect of the present disclosure, the control signal may be a signal complying with IEEE 802.11bf.

In the communication device according to the first aspect of the present disclosure, the controller may be configured to establish a session with the second communication device using the control signal prior to transmission or reception of the first measurement signal and the second measurement signal.

In the communication device according to the first aspect of the present disclosure, the controller may be configured to transmit both a parameter related to the spatial sensing using the first measurement signal and a parameter related to the spatial sensing using the second measurement signal, to the second communication device using the control signal when the session with the second communication device is established.

In the communication device according to the first aspect of the present disclosure, the controller may be configured to receive measurement results by the first measurement signal and the second measurement signal from the second communication device using the control signal when the first measurement signal and the second measurement signal are transmitted to the second communication device.

In the communication device according to the first aspect of the present disclosure, the controller may be configured to terminate the session with the second communication device using the control signal, after receiving the measurement results.

A communication method according to a second aspect of the present disclosure is executed by a first communication device in a spatial sensing system including the first communication device and a second communication device. The communication method includes transmitting a control signal for controlling both spatial sensing using a first measurement signal and spatial sensing using a second measurement signal to the second communication device in a first frequency band. The communication method includes transmitting to the second communication device or receiving from the second communication device, the first measurement signal in the first frequency band. The communication method includes transmitting to the second communication device or receiving from the second communication device, the second measurement signal in a second frequency band higher than the first frequency band.

In the communication method according to the second aspect of the present disclosure, the first frequency band may be a frequency band lower than 10 GHz. The second frequency band may be a frequency band equal to or higher than 10 GHz.

In the communication method according to the second aspect of the present disclosure, the control signal may be transmitted to the second communication device prior to transmission or reception of the first measurement signal and the second measurement signal.

In the communication method according to the second aspect of the present disclosure, the control signal may be a signal that transmits both a parameter related to the spatial sensing using the first measurement signal and a parameter related to the spatial sensing using the second measurement signal, to the second communication device.

In the communication method according to the second aspect of the present disclosure, the control signal may be a signal complying with IEEE 802.11bf.

In the communication method according to the second aspect of the present disclosure, a session with the second communication device may be established using the control signal prior to transmission or reception of the first measurement signal and the second measurement signal.

In the communication method according to the second aspect of the present disclosure, when the session with the second communication device is established, both a parameter related to the spatial sensing using the first measurement signal and a parameter related to the spatial sensing using the second measurement signal may be transmitted to the second communication device using the control signal.

In the communication method according to the second aspect of the present disclosure, when the first measurement signal and the second measurement signal are transmitted to the second communication device, measurement results by the first measurement signal and the second measurement signal may be received from the second communication device using the control signal.

In the communication method according to the second aspect of the present disclosure, the session with the second communication device may be terminated using the control signal after the measurement results are received.

A non-transitory storage medium according to a third aspect of the present disclosure stores a command executable by one or more processors, the command causing the one or more processors to execute the communication method according the second aspect of the present disclosure.

According to the present disclosure, it is possible to achieve balance between accuracy and speed of spatial sensing.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic view for explaining spatial sensing using wireless signals;

FIG. 2A is a first view for explaining a relationship between an initiator and a responder;

FIG. 2B is a second view for explaining the relationship between the initiator and the responder;

FIG. 3 is a hardware configuration diagram of a communication device according to an embodiment;

FIG. 4 is a software configuration diagram of an initiator according to the embodiment;

FIG. 5 is a software configuration diagram of a responder according to the embodiment;

FIG. 6 is a flowchart for explaining phases to be executed by each device;

FIG. 7 is a sequence diagram indicating flow of data in a detection phase;

FIG. 8 is a sequence diagram indicating flow of data in a measurement setup phase;

FIG. 9 is a sequence diagram indicating flow of data in a measurement phase; and

FIG. 10 is a sequence diagram indicating flow of data in a measurement termination phase.

### DETAILED DESCRIPTION OF EMBODIMENTS

In recent years, a technique for performing sensing within a space by utilizing a radio wave in a GHz band that is license free has been studied.

In the spatial sensing, a transmitter transmits a signal for measurement in a predetermined frequency band, and a receiver receives the signal. The receiver analyzes the signal and generates information indicating propagation characteristics of wireless signals. By analyzing the information, it is possible to estimate a position, motion, and the like of an object existing within the space.

Examples of a frequency band to be used in spatial sensing may include a frequency band of a microwave such as a 5 GHz band, and a frequency band of a millimeter wave such as a 60 GHz band.

The respective frequency bands have characteristics, and the frequency band is selected according to purpose of sensing. For example, a radio wave in a low frequency band has low directivity, and thus, is appropriate for sensing of a wide range. On the other hand, the radio wave in the low frequency band has a relatively long wavelength, and thus, is not appropriate for purpose of detecting existence and motion of a small object. Further, a radio wave in a high frequency band has a short wavelength, and thus, can be used to detect existence and motion of a smaller object. On the other hand, the radio wave in the high frequency band has high directivity, thus, processing such as sector scan is required, and a wide range cannot be measured in a short period of time.

In order to balance these advantages and disadvantages, it is conceivable to perform spatial sensing using a plurality of frequency bands. However, in the known standards such as IEEE 802.11bf, use of a plurality of frequency bands in spatial sensing is not taken into account.

A communication device in the present disclosure solves this problem.

A communication device according to a first aspect of the present disclosure is a communication device that functions as a first communication device in a spatial sensing system including the first communication device and a second communication device and includes a controller configured to execute transmitting a control signal for controlling both spatial sensing using a first measurement signal and spatial sensing using a second measurement signal, to the second communication device in a first frequency band, transmitting to the second communication device or receiving from the second communication device, the first measurement signal in the first frequency band, and transmitting to the second communication device or receiving from the second communication device, the second measurement signal in a second frequency band higher than the first frequency band.

In the spatial sensing, a communication device (transmitter) that transmits a measurement signal, and a communication device (receiver) that receives a measurement signal are utilized. The first communication device may be either a transmitter or a receiver.

When the first communication device is a transmitter, the second communication device becomes a receiver. When the first communication device is a transmitter, the controller transmits the first measurement signal to the second communication device in the first frequency band and transmits the second measurement signal to the second communication device in the second frequency band higher than the first frequency band.

When the first communication device is a receiver, the second communication device becomes a transmitter. When the first communication device is a receiver, the controller receives the first measurement signal from the second communication device in the first frequency band and receives the second measurement signal from the second communication device in the second frequency band higher than the first frequency band.

Further, the controller transmits a control signal for controlling both spatial sensing using the first measurement signal and spatial sensing using the second measurement signal, to the second communication device in the first frequency band.

In other words, while the communication device according to the present disclosure transmits or receives the measurement signals by respectively utilizing a plurality of frequency bands, the communication device transmits the control signal for controlling measurement by utilizing a lower frequency band (first frequency band).

The control signal is typically a signal that transmits both a parameter related to the spatial sensing using the first measurement signal and a parameter related to the spatial sensing using the second measurement signal, to the second communication device. Further, the control signal may be, for example, a signal to be utilized to find a partner side communication device, transmit the measurement results, and the like.

The control signal may be transmitted to the second communication device prior to transmission or reception of the first measurement signal and the second measurement signal.

While the control signals can be transmitted in respective frequency bands, the control signals do not require a high bit rate or high directivity. Thus, by collectively transmitting two types of control signals in the first frequency band, it is possible to improve communication reliability and reduce time required for spatial sensing.

Note that the first frequency band may be a frequency band lower than 10 GHz, and the second frequency band may be a frequency band equal to or higher than 10 GHz. Further, the control signal may be a signal complying with IEEE 802.11bf.

Further, the controller may establish a session with the second communication device using the control signal prior to transmission or reception of the first measurement signal and the second measurement signal.

Still further, the controller may transmit both the parameter related to the spatial sensing using the first measurement signal and the parameter related to the spatial sensing using the second measurement signal, to the second communication device using the control signal when the session with the second communication device is established.

Yet further, the controller may receive measurement results by the first measurement signal and the second measurement signal from the second communication device using the control signal when the first measurement signal and the second measurement signal are transmitted to the second communication device.

Further, the controller may terminate the session with the second communication device using the control signal, after receiving the measurement results.

A specific embodiment of the present disclosure will be described below based on the drawings. A hardware configuration, a module configuration, a functional configuration, and the like, described in the embodiment do not intend to limit a technical scope of the disclosure thereto unless otherwise described.

### First Embodiment

### Outline of System

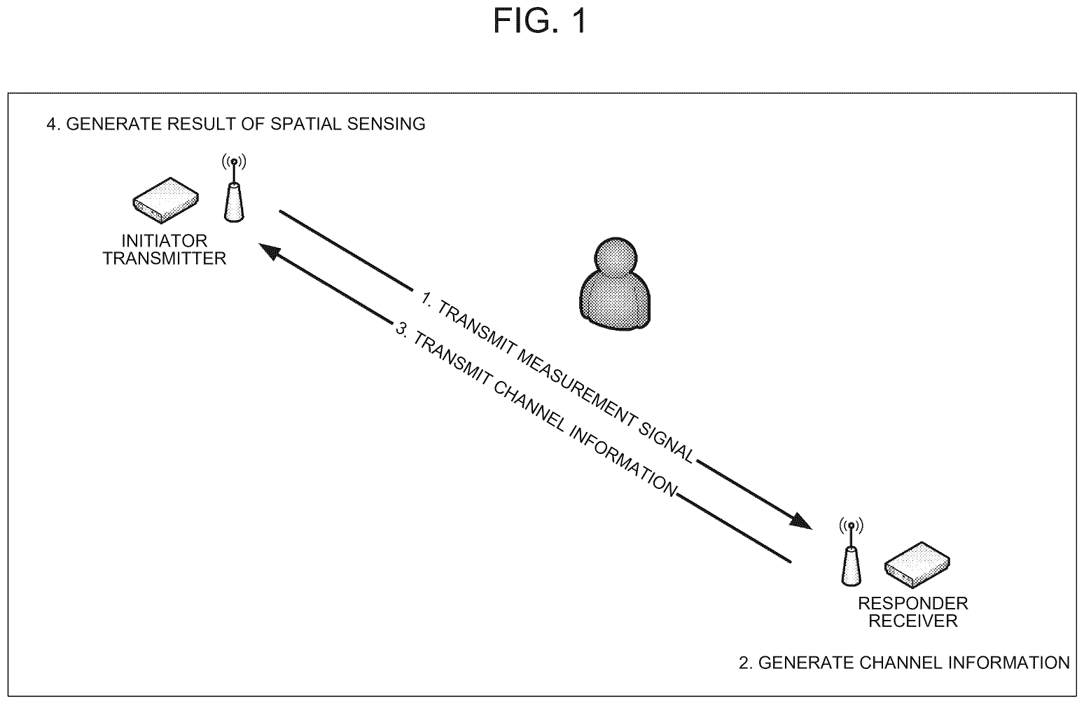

Outline of a spatial sensing system according to a first embodiment will be described with reference to FIG. 1. The spatial sensing system according to the present embodiment includes an initiator and a responder provided indoors.

The spatial sensing system according to the present embodiment is a system that performs spatial sensing according to procedure specified by IEEE 802.11bf. The spatial sensing defined by the standards is a method in which a position, motion, a shape, and the like, of an object located within a target space (for example, an indoor room) are acquired by utilizing wireless signals of Wi-Fi (registered trademark).

In the standards, spatial sensing is performed by four types of communication devices of an initiator, a responder, a transmitter, and a receiver.

The initiator is a device that starts measurement procedure and finally acquires a measurement result, and the transmitter is a device that actually transmits the measurement signal. The responder is a device that participates in measurement in accordance with an instruction from the initiator, and the receiver is a device that actually receives the measurement signal.

The initiator and the transmitter may be the same device, and the responder and the receiver may be the same device. In this case, as illustrated in FIG. 1, (1) the measurement signal is transmitted from the initiator and received by the responder. Further, (2) the responder generates channel information based on the received measurement signal. Then, (3) the responder transmits the generated channel information to the initiator, and (4) the initiator generates a result of the spatial sensing based on the channel information.

Note that the initiator can serve as the receiver, and the responder can serve as the transmitter. In this case, the responder transmits the measurement signal in accordance with an instruction from the initiator, and the initiator generates a measurement result.

While in the following embodiment, an embodiment will be described where the initiator is the transmitter, and the responder is the receiver, the embodiment is not limited to this. In the description of the embodiment, the former will be referred to as an initiator 10, and the latter will be referred to as a responder 20. The initiator 10 is one example of the “first communication device”, and the responder 20 is one example of the “second communication device”.

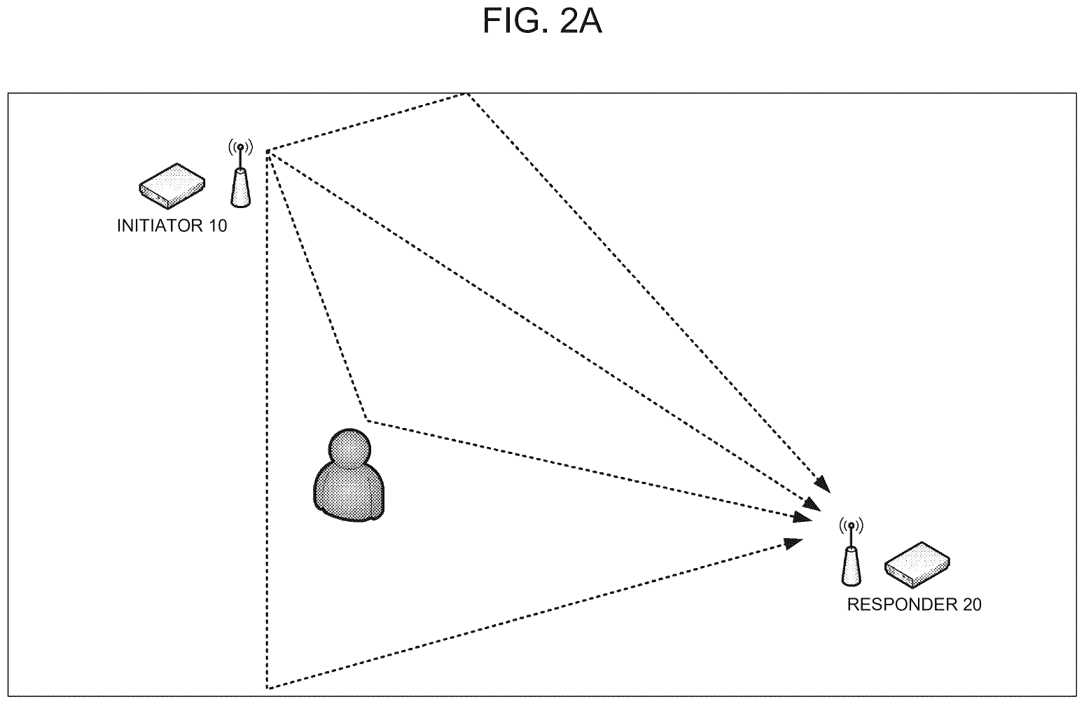

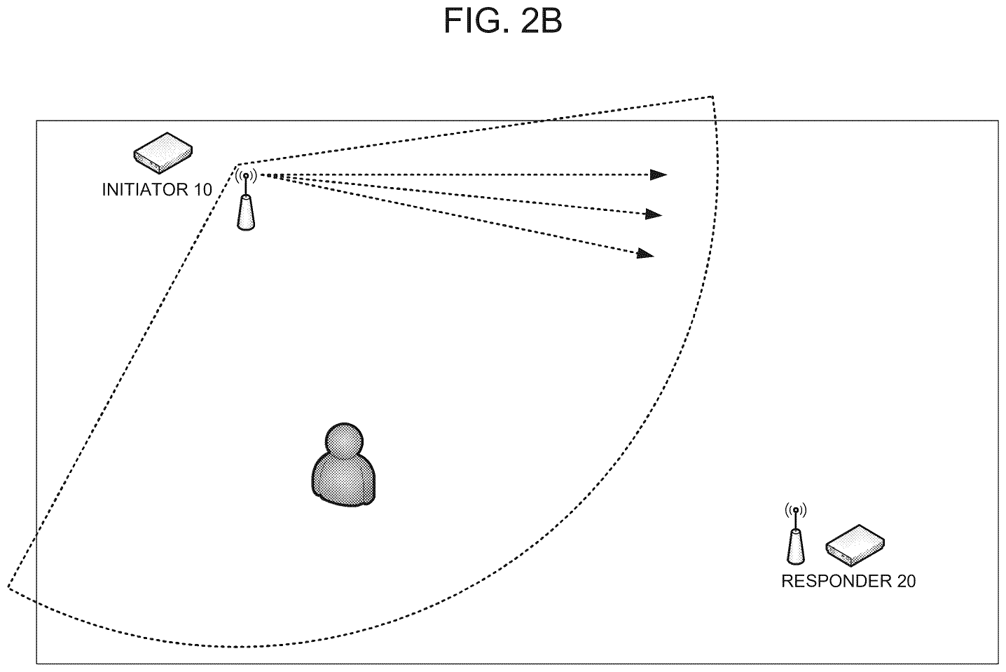

FIG. 2A is a view for explaining a propagation path of wireless signals between the initiator 10 and the responder 20. As illustrated, the measurement signal transmitted from the initiator 10 is reflected by an obstacle, a wall, or the like, and reaches the responder 20. The responder 20 measures attenuation of the propagation path, a delay, frequency shift, a multipath effect, and the like, using a known channel analysis method and generates channel information. The channel information is also referred to as channel state information (CSI) information. The initiator 10 receives the CSI information from the responder 20 and generates a result of the spatial sensing based on the CSI information.

While FIG. 2A illustrates an example in a case where omnidirectional transmission is performed, when a measurement signal in a high frequency band is utilized, there can be also a case where sector scan is performed. For example, as illustrated in FIG. 2B, the initiator 10 performs beamforming and transmits the measurement signal a plurality of times while changing a beam transmission direction. By integrating a plurality of pieces of CSI information obtained as a result of this, existence, motion, a shape, and the like, of an object existing in the space can be estimated.

### Hardware Configuration

A hardware configuration of the respective devices constituting the system will be described next.

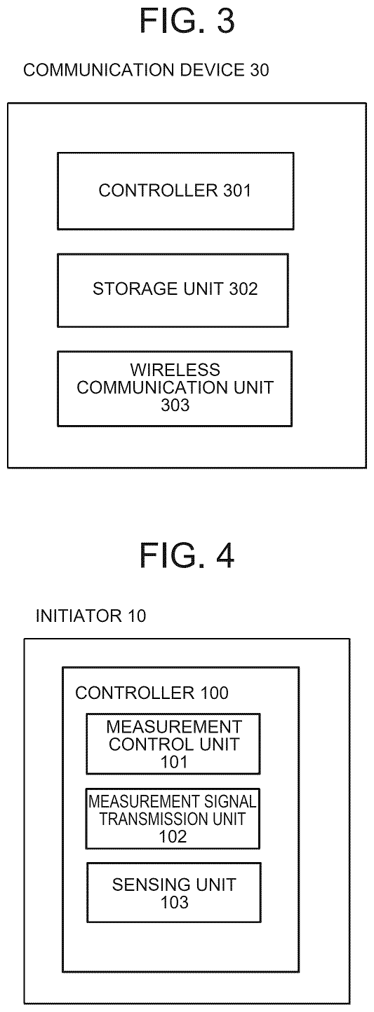

FIG. 3 is a view schematically illustrating one example of a hardware configuration of a communication device 30 (information processing device) operable as the initiator 10 and the responder 20.

The communication device 30 is constituted as a computer including a processor (such as a CPU and a GPU), a main storage device (such as a RAM and a ROM), and an auxiliary storage device (such as an EPROM, a hard disk drive and a removable medium). In the auxiliary storage device, an operating system (OS), various kinds of programs, various kinds of tables, and the like, are stored, and respective functions (software modules) that match predetermined purposes as will be described later can be implemented by the programs stored therein being executed. However, some or all of the functions may be implemented as, for example, hardware modules by hardware circuits such as an ASIC and an FPGA.

The communication device 30 includes a controller 301, a storage unit 302 and a wireless communication unit 303.

The controller 301 is an arithmetic unit that implements various kinds of functions of the communication device 30 by executing predetermined programs. The controller 301 can be implemented by, for example, a hardware processor such as a CPU. Further, the controller 301 may include a RAM, a read only memory (ROM), a cache memory, and the like.

The storage unit 302, which stores information, is constituted with a storage medium such as a RAM, a magnetic disk, and a flash memory. In the storage unit 302, programs to be executed by the controller 301, data to be utilized by the programs, and the like, are stored.

The wireless communication unit 303 is a wireless communication interface for transmitting and receiving a measurement signal for performing spatial sensing and a control signal for controlling the spatial sensing. The wireless communication unit 303 is, for example, constituted so as to be able to transmit and receive wireless signals that meet standards of a wireless LAN, and the like. Further, the wireless communication unit 303 can transmit and receive these wireless signals in two different frequency bands. In the present embodiment, the wireless communication unit 303 can transmit and receive the wireless signals in two frequency bands of a 5 GHz band (first frequency band) and a 60 GHz band (second frequency band).

### Software Configuration

A software configuration of the respective devices constituting the system will be described next. FIG. 4 is a view schematically illustrating a software configuration of the initiator 10 according to the present embodiment. The hardware configuration of the initiator 10 is as illustrated in FIG. 3.

In the present embodiment, the initiator 10 includes a logical controller 100 corresponding to the controller 301. The controller 100 includes three software modules of a measurement control unit 101, a measurement signal transmission unit 102 and a sensing unit 103. Each software module may be implemented by a program stored in the storage unit 302 being executed by the controller 301 (such as a CPU). Note that information processing to be executed by the software module is synonymous with information processing to be executed by the controller 301 (such as a CPU).

The measurement control unit 101 manages transmission and reception of the control signal for performing the spatial sensing. Specifically, the measurement control unit 101 executes processing of detecting the responder 20 and performing negotiation, processing of exchanging a parameter necessary for measurement with the responder 20, processing of terminating a session after measurement is completed, and the like. The measurement control unit 101 transmits and receives wireless signals necessary for these kinds of processing by utilizing only the first frequency band.

The measurement signal transmission unit 102 manages transmission of the measurement signal for performing the spatial sensing. Specifically, the measurement signal transmission unit 102 transmits the measurement signal to the responder 20 at a timing at which negotiation between the initiator 10 and the responder 20 is completed, and measurement preparation is completed. The measurement signal may be a signal in which user data is not stored in a payload. In other words, the measurement signal may be a signal in which a packet only including a header is encoded.

The measurement signal transmission unit 102 transmits the measurement signal both in the first frequency band (5 GHz band) and in the second frequency band (60 GHz band). Hereinafter, the measurement signal transmitted in the first frequency band will be referred to as a first measurement signal, and the measurement signal transmitted in the second frequency band will be referred to as a second measurement signal.

While the first measurement signal is an omnidirectional signal as illustrated in FIG. 2A, the second measurement signal is a signal in a high frequency band, and thus, the second measurement signal is transmitted a plurality of times while a beam direction is changed as illustrated in FIG. 2B.

The measurement signal transmitted by the measurement signal transmission unit 102 is received and analyzed by the responder 20. The responder 20 performs analysis on each of the first measurement signal and the second measurement signal.

Further, the measurement signal transmission unit 102 receives an analysis result (report) generated by the responder 20 from the responder 20. The report includes CSI information generated by analyzing the measurement signal. The CSI information is also generated for each of the first measurement signal and the second measurement signal.

The sensing unit 103 performs sensing of an object existing within the space based on the CSI information received from the responder 20. The sensing may be, for example, processing of detecting that an unknown object is located within the space. For example, when an intruder, or the like, is located within a space that is a security target, the CSI information transmitted from the responder 20 changes. Thus, for example, by causing the sensing unit 103 to learn CSI information corresponding to an empty space, it becomes possible to detect an intruder, or the like, existing within the space.

Further, the sensing may be processing of estimating a shape of an object existing within the space. For example, by analyzing the CSI information, the sensing unit 103 can estimate a shape of the object existing within the target space. Note that when the second frequency band is utilized in the measurement, a more accurate shape can be estimated than when the first frequency band is utilized. In this case, the shape of the object may be estimated by receiving from the responder 20, a plurality of pieces of CSI information respectively corresponding to the measurement signals transmitted a plurality of times while the beam direction is changed and analyzing the CSI information.

Further, the sensing may be operation of estimating motion of the object existing within the space. For example, the motion of the object existing within the space can be estimated by transmitting the measurement signals a plurality of times over time and receiving and analyzing the CSI information corresponding to the measurement signals.

The sensing result generated by the sensing unit 103 is transmitted to outside or stored in the storage unit 302 and used for predetermined purpose.

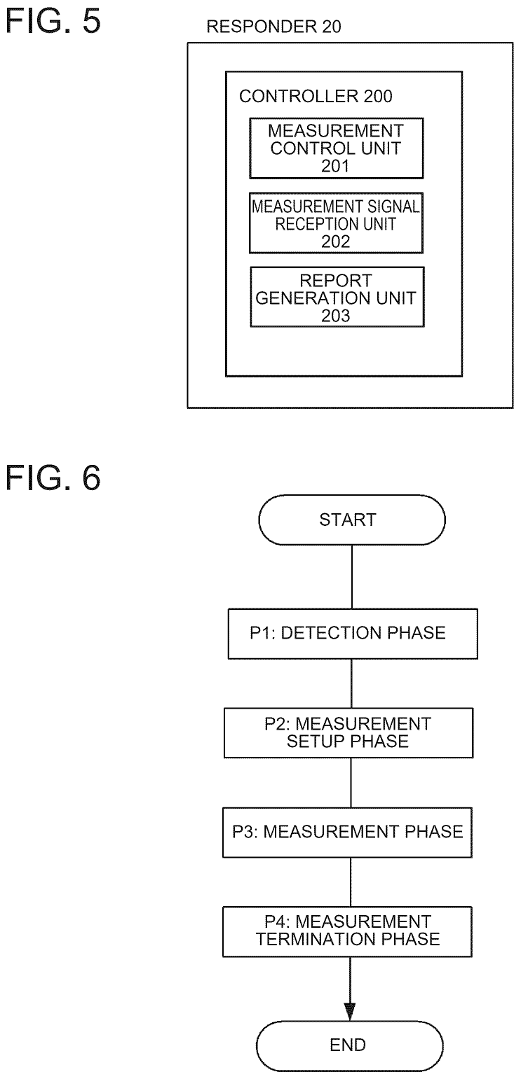

A software configuration of the responder 20 will be described next. FIG. 5 is a view schematically illustrating the software configuration of the responder 20 according to the present embodiment. The hardware configuration of the responder 20 is as illustrated in FIG. 3.

In the present embodiment, the responder 20 includes a logical controller 200 corresponding to the controller 301. The controller 200 includes three software modules of a measurement control unit 201, a measurement signal reception unit 202 and a report generation unit 203. Each software module may be implemented by the program stored in the storage unit 302 being executed by the controller 301 (such as a CPU). Note that information processing to be executed by the software module is synonymous with information processing to be executed by the controller 301 (such as a CPU).

The measurement control unit 201 manages transmission and reception of the control signal for performing the spatial sensing. Specifically, the measurement control unit 201 executes processing of performing negotiation in response to a request from the initiator 10, processing of exchanging a parameter required for measurement with the initiator 10, processing of terminating a session after measurement is completed, and the like. The measurement control unit 201 transmits and receives the wireless signals necessary for these kinds of processing by utilizing only the first frequency band.

The measurement signal reception unit 202 manages reception of the measurement signal for performing the spatial sensing. Specifically, the measurement signal reception unit 202 receives the measurement signal transmitted from the initiator 10. The measurement signal reception unit 202 receives the measurement signal both in the first frequency band (5 GHz band) and in the second frequency band (60 GHz band).

The report generation unit 203 analyzes the measurement signal transmitted from the initiator 10 and generates CSI information that is information representing characteristics of a transmission path. The CSI information is information representing a state of a wireless channel and, for example, includes information regarding attenuation of the wireless signals, phase shift caused by reflection of the wireless signals, multipath characteristics, and the like. The report generation unit 203 transmits the generated CSI information to the initiator 10 as a report for the measurement signal.

Note that the report generation unit 203 may unconditionally transmit the CSI information to the initiator 10 after receiving the measurement signal or may transmit the CSI information to the initiator 10 only when a predetermined condition is satisfied. For example, when a target of sensing is motion of the object, the CSI information may be transmitted to the initiator 10 when a predetermined value indicated by the CSI information has fluctuated exceeding a predetermined threshold.

Note that as described above, the CSI information is generated for each of the first measurement signal and the second measurement signal.

### Processing Flowchart

Flow of processing in the spatial sensing will be described next. FIG. 6 is a view for explaining phases of processing to be executed by the initiator 10 and the responder 20 according to the present embodiment. In the present embodiment, the spatial sensing is performed in four divided phases.

A first phase (P1) is a phase (detection phase) in which the initiator 10 and the responder 20 recognize each other's existence and perform negotiation. In the detection phase, the initiator 10 transmits a request frame for detecting the responder 20. The responder 20 determines whether the own device can respond to the request transmitted from the initiator 10 and returns a response frame.

Only the first frequency band is used for transmission and reception of the frames in the detection phase.

The next phase (P2) is a phase (measurement setup phase) in which the initiator 10 and the responder 20 exchange information necessary for the spatial sensing. In the measurement setup phase, the initiator 10 and the responder 20 transmit and receive information regarding a parameter to be utilized for measurement, a type of the measurement, a measurement period, and the like, and share these kinds of information. Further, the initiator 10 and the responder 20 exchange and share an ID for uniquely identifying the session and the measurement.

Only the first frequency band is used for transmission and reception of the frames in the measurement setup phase.

When the measurement setup phase is completed, a measurement phase (P3) is started. In the measurement phase, the measurement signal is transmitted from the initiator 10 to the responder 20 in each of the first frequency band and the second frequency band. The responder 20 generates a report (CSI information) based on the received measurement signal. Further, the responder 20 transmits the generated CSI information to the initiator 10.

When the measurement phase is completed, a measurement termination phase (P4) is started. The measurement termination phase is a phase for terminating the measurement set up in the measurement setup phase (P2). In the present phase, the initiator 10 and the responder 20 transmit an ID for uniquely identifying the measurement and terminate the corresponding measurement. Note that when measurement is consecutively executed a plurality of times, processing may be caused to transition to the measurement setup phase again, and then, new measurement may be started.

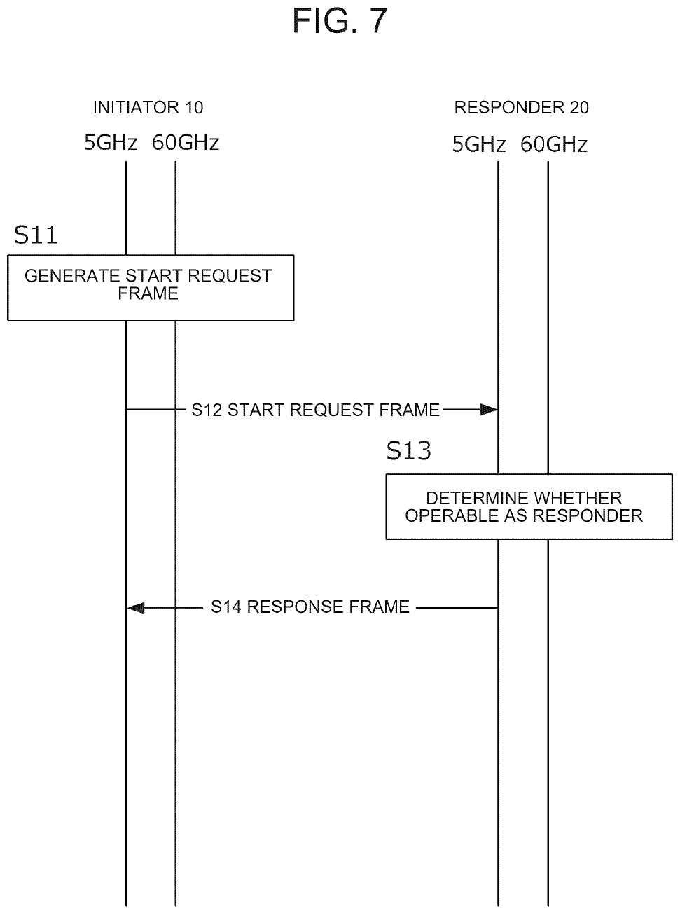

Processing to be executed by the respective devices in the respective phases described above will be specifically described next. FIG. 7 is a sequence diagram of data to be transmitted and received between the initiator 10 and the responder 20 in the detection phase. The indicated processing is started at a timing at which the spatial sensing is started.

First, in step S11, the initiator 10 (measurement control unit 101) generates a start request frame. The start request frame is a frame for starting negotiation with the responder 20. When the responder 20 is known, the start request frame may include an address, or the like, of the responder 20 that is a destination. Further, when the responder 20 is unknown, the start request frame may be broadcasted. The start request frame may also include information designating requirements (such as, for example, a supported frequency band) that are to be satisfied by the responder.

The generated start request frame is transmitted to the responder 20 by wireless signals in the first frequency band (5 GHz band) (step S12).

When the responder 20 receives the start request frame, the responder 20 (measurement control unit 201) determines whether the own device can respond to the initiator 10 (step S13). For example, when the frequency band, and the like, are designated by the start request frame, the responder 20 may determine whether the own device satisfies the requirements (for example, whether the own device supports the frequency band). Further, the responder 20 may determine whether the designated frequency band is currently available.

When the responder 20 determines that the responder 20 can respond to the initiator 10, a response frame is transmitted to the initiator 10 (step S14). The response frame is also transmitted to the initiator 10 using wireless signals in the first frequency band (5 GHz band). The initiator 10 that has received the response frame can recognize the responder 20 that responds.

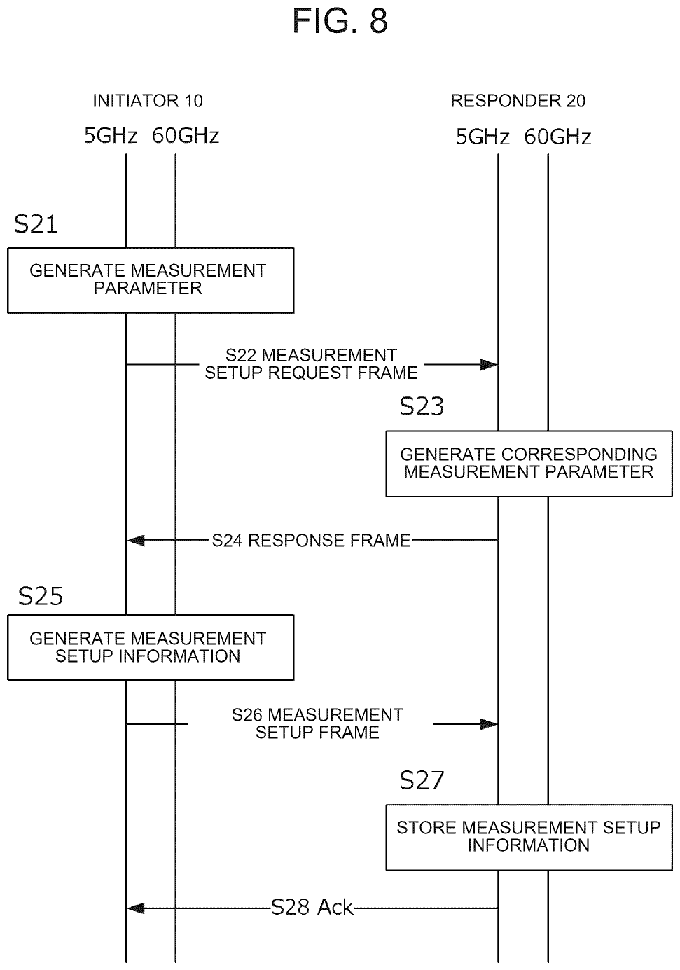

FIG. 8 is a sequence diagram of data to be transmitted and received between the initiator 10 and the responder 20 in the measurement setup phase. The indicted processing is started at a timing at which the detection phase is completed, that is, a timing at which the initiator 10 and the responder 20 recognize each other's existence.

The initiator 10 (measurement control unit 101) generates a parameter (measurement parameter) to be utilized for the measurement (step S21). The measurement parameter may include data designating a type of the measurement, a type of a report requested as a result of the measurement, a measurement period, and the like, as well as data designating various kinds of values to be utilized for the measurement. The initiator 10 transmits a measurement setup request (MSRQ) frame including the measurement parameter to the responder 20 (step S22).

The responder 20 that has received the measurement setup request frame generates the measurement parameter to be utilized by the own device in response to the measurement parameter received from the initiator 10 (step S23). For example, when the initiator 10 presents a plurality of available measurement parameters, the responder 20 may determine and return the measurement parameter to be actually utilized among the plurality of measurement parameters.

The responder 20 transmits a measurement setup response (MSRP) frame including the measurement parameter generated by the own device to the initiator 10 (step S24).

The MSRQ and the MSRP are one example of the “control signal” in the present disclosure.

Note that the measurement parameter described above is generated for each of the first frequency band (5 GHz band) and the second frequency band (60 GHz band). In other words, both the measurement parameter when measurement is performed by the first measurement signal using the first frequency band, and the measurement parameter when measurement is performed by the second measurement signal using the second frequency band are generated.

The measurement setup request frame and the measurement setup response frame including these measurement parameters are transmitted and received by wireless signals in the first frequency band (5 GHz band).

When exchange of the measurement parameter is completed, the initiator 10 generates measurement setup information (step S25). The measurement setup information includes information for uniquely identifying measurement set up by the processing from step S21 to S24 (which will be referred to as a measurement setup ID) and information for uniquely identifying a measurement instance (which will be referred to as a measurement instance ID).

The measurement setup information is transmitted from the initiator 10 to the responder 20 by the measurement setup frame (step S26). The responder 20 stores the received measurement setup information (step S27) and transmits an acknowledgement (step S28).

Note that the measurement setup information described above is also generated for each of the first frequency band (5 GHz band) and the second frequency band (60 GHz band).

The measurement setup frame and the acknowledgement described above are transmitted and received by the wireless signals in the first frequency band (5 GHz band).

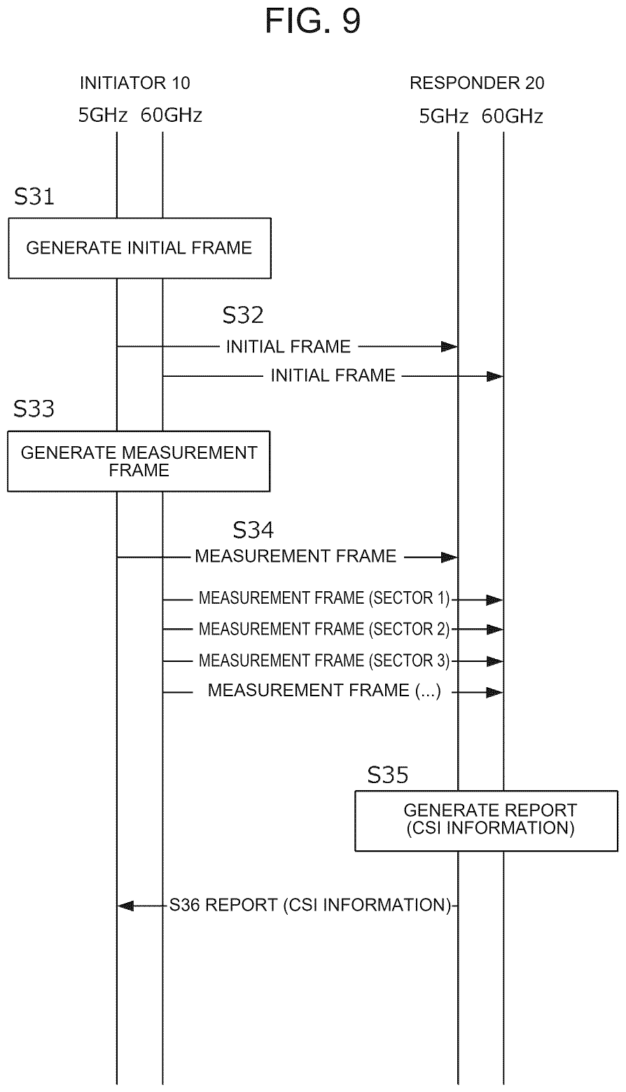

FIG. 9 is a sequence diagram of data to be transmitted and received between the initiator 10 and the responder 20 in the measurement phase. The indicated processing is started at a timing at which the measurement setup phase is completed, that is, a timing at which the initiator 10 and the responder 20 exchange the measurement parameter and complete sharing of the measurement setup information.

First, in step S31, the initiator 10 (measurement signal transmission unit 102) generates an initial frame. The initial frame is a frame including the measurement instance ID and data designating an instance period.

The instance period is a period required for measurement of one time. For example, while the measurement frame is transmitted once when measurement is performed in the first frequency band, it is necessary to transmit the measurement frame a plurality of times when measurement is performed in the second frequency band, because sector scan is performed. As a result of the instance period being designated, the responder 20 can specify a measurement period for each measurement frame.

The initial frame is transmitted from the initiator 10 to the responder 20 in each of the first frequency band and the second frequency band (step S32).

Then, the initiator 10 (measurement signal transmission unit 102) generates a measurement frame (step S33). In the present embodiment, the measurement frame is a frame in which user data is not stored in a payload. In other words, the measurement frame is a frame including only a header. The measurement frame is generated for each of the first frequency band (5 GHz band) and the second frequency band (60 GHz band).

When the measurement frame is generated, the initiator 10 (measurement signal transmission unit 102) transmits the generated measurement frame to the responder 20 (step S34). Note that as described above, the measurement frame is transmitted once using the first frequency band, and the measurement frame is transmitted a plurality of times using the second frequency band. For example, when beams are transmitted in a range of 180 degrees, and when scanning is performed twice each time, the measurement frame is transmitted 90 times.

The measurement frame is received by the responder 20 (measurement signal reception unit 202). When the designated instance period elapses, the responder 20 (report generation unit 203) starts analysis of the received measurement frame and generates a report (CSI information) (step S35). Note that the CSI information is generated for each sector for the second frequency band in which sector scan is performed.

The generated report (CSI information) is transmitted from the responder 20 to the initiator 10 (step S36).

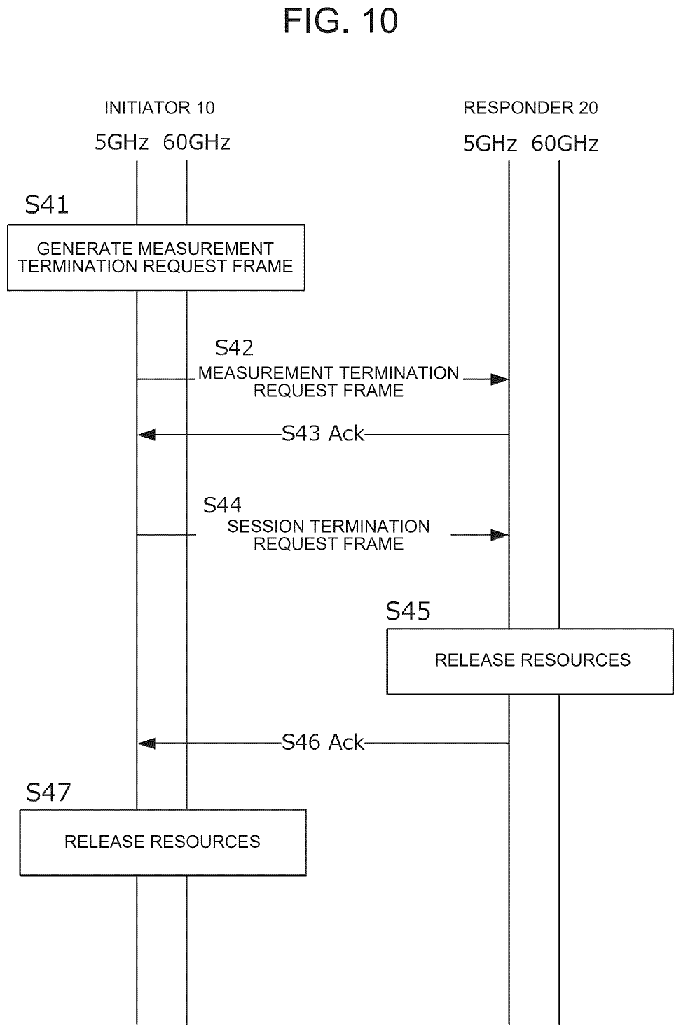

FIG. 10 is a sequence diagram of data to be transmitted and received between the initiator 10 and the responder 20 in the measurement termination phase. The indicated processing is started at a timing at which the measurement phase is completed, that is, a timing at which transmission of the report from the responder 20 to the initiator 10 is completed.

First, in step S41, the initiator 10 (measurement control unit 101) generates a measurement termination request (or measurement setup terminate request, MSTR) frame. The measurement termination request frame is a request for terminating specific measurement and includes a measurement setup ID of the measurement to be terminated. The measurement termination request frame is transmitted from the initiator 10 to the responder 20 (step S42).

The responder 20 that has received the measurement termination request frame prepares for the requested termination of the measurement and transmits an acknowledgement to the initiator 10 (step S43).

The initiator 10 that has received the acknowledgement generates a frame for terminating the session with the responder 20 (session termination request frame) and transmits the frame to the responder 20 (step S44).

The responder 20 that has received the session termination request frame releases resources of both the first frequency band and the second frequency band (step S45) and transmits an acknowledgement to the initiator 10 (step S46).

The initiator 10 that has received the acknowledgement releases resources of both the first frequency band and the second frequency band (step S47).

The initiator 10 that has acquired the CSI information from the responder 20 performs predetermined processing by utilizing the CSI information. The predetermined processing is processing of detecting existence of an object, processing of detecting motion of the object, processing of estimating a shape of the object, and the like. Note that when an application that performs these kinds of processing is running on an external device, the initiator 10 may transmit the acquired CSI information or data generated based on the CSI information to the external device.

As described above, in the spatial sensing system according to the present embodiment, the initiator 10 transmits the measurement frame by utilizing both the first frequency band and the second frequency band, and the responder 20 generates CSI information based on the measurement frame. This makes it possible to perform spatial sensing while making use of advantages of both frequency bands.

Further, in the spatial sensing system according to the present embodiment, two types of control signals for performing measurement using two frequency bands are transmitted and received by utilizing only the first frequency band. Typically, the control signal does not require a high bit rate and high directivity. Thus, by collectively transmitting two types of control signals in the first frequency band that has better connectivity, it is possible to improve reliability of communication and reduce time required for spatial sensing.

### MODIFICATION

The above-described embodiment is merely one example, and the present disclosure can be modified as appropriate within a range not deviating from the gist.

For example, the processing and the elements described in the present disclosure can be freely combined and implemented unless technical inconsistencies arise.

Further, while in the embodiment, an embodiment in which the initiator is the transmitter, and the responder is the receiver has been exemplified, the initiator can serve as the receiver, and the responder can serve as the transmitter. In this case, the responder may transmit the measurement frame in accordance with an instruction from the initiator, and the initiator may generate a report (CSI information).

Further, while in the embodiment, the initiator 10 is exemplified as one example of the “first communication device”, and the responder 20 is exemplified as one example of the “second communication device”, the initiator 10 may be the “second communication device”, and the responder 20 may be the “first communication device”.

Still further, while in the embodiment, the first frequency band is set at a 5 GHz band, and the second frequency band is set at a 60 GHz band, other frequency bands may be utilized. In some embodiments, the first frequency band is a frequency band lower than 10 GHZ, and the second frequency band is a frequency band equal to or higher than 10 GHz.

Further, while in the embodiment, data complying with IEEE 802.11bf is exemplified as data to be transmitted and received between the devices, the data is not limited to this.

Still further, the processing described as being performed by one device may be shared and executed by a plurality of devices. Alternatively, the processing described as being performed by different devices may be executed by one device. In a computer system, what kind of hardware configuration (server configuration) is used to implement the respective functions can be flexibly changed.

The present disclosure can be implemented by a computer program implementing the functions described in the above embodiment being supplied to a computer and one or more processors of the computer reading and executing the program. Such a computer program may be provided to the computer using a non-transitory computer-readable storage medium that can be connected to a system bus of the computer or may be provided to the computer via a network. The non-transitory computer-readable storage medium includes, for example, an any type of disk such as a magnetic disk (such as a floppy (registered trademark) disk and a hard disk drive (HDD)) and an optical disk (such as a CD-ROM, a DVD disk and a blue-ray disk), a read only memory (ROM), a random access memory (RAM), an EPROM, an EEPROM, a magnetic card, a flash memory, an optical card, and an any type of medium appropriate for storing an electronic command.

What is claimed is:

1. A communication device functioning as a first communication device in a spatial sensing system including the first communication device and a second communication device, the communication device comprising a controller configured to execute:
transmitting a control signal for controlling both spatial sensing using a first measurement signal and spatial sensing using a second measurement signal to the second communication device in a first frequency band;
transmitting to the second communication device or receiving from the second communication device, the first measurement signal in the first frequency band; and
transmitting to the second communication device or receiving from the second communication device, the second measurement signal in a second frequency band higher than the first frequency band.

2. The communication device according to claim 1, wherein the first frequency band is a frequency band lower than 10 GHZ, and the second frequency band is a frequency band equal to or higher than 10 GHz.

3. The communication device according to claim 1, wherein the controller is configured to transmit the control signal to the second communication device prior to transmission or reception of the first measurement signal and the second measurement signal.

4. The communication device according to claim 3, wherein the control signal is a signal that transmits both a parameter related to the spatial sensing using the first measurement signal and a parameter related to the spatial sensing using the second measurement signal, to the second communication device.

5. The communication device according to claim 1, wherein the control signal is a signal complying with IEEE 802.11bf.

6. The communication device according to claim 1, wherein the controller is configured to establish a session with the second communication device using the control signal prior to transmission or reception of the first measurement signal and the second measurement signal.

7. The communication device according to claim 6, wherein the controller is configured to transmit both a parameter related to the spatial sensing using the first measurement signal and a parameter related to the spatial sensing using the second measurement signal, to the second communication device using the control signal when the session with the second communication device is established.

8. The communication device according to claim 7, wherein the controller is configured to receive measurement results by the first measurement signal and the second measurement signal from the second communication device using the control signal when the first measurement signal and the second measurement signal are transmitted to the second communication device.

9. The communication device according to claim 8, wherein the controller is configured to terminate the session with the second communication device using the control signal, after receiving the measurement results.

10. A communication method to be executed by a first communication device in a spatial sensing system including the first communication device and a second communication device, the communication method comprising:
transmitting a control signal for controlling both spatial sensing using a first measurement signal and spatial sensing using a second measurement signal to the second communication device in a first frequency band;
transmitting to the second communication device or receiving from the second communication device, the first measurement signal in the first frequency band; and
transmitting to the second communication device or receiving from the second communication device, the second measurement signal in a second frequency band higher than the first frequency band.

11. The communication method according to claim 10, wherein the first frequency band is a frequency band lower than 10 GHz, and the second frequency band is a frequency band equal to or higher than 10 GHz.

12. The communication method according to claim 10, wherein the control signal is transmitted to the second communication device prior to transmission or reception of the first measurement signal and the second measurement signal.

13. The communication method according to claim 12, wherein the control signal is a signal that transmits both a parameter related to the spatial sensing using the first measurement signal and a parameter related to the spatial sensing using the second measurement signal, to the second communication device.

14. The communication method according to claim 10, wherein the control signal is a signal complying with IEEE 802.11bf.

15. The communication method according to claim 10, wherein a session with the second communication device is established using the control signal prior to transmission or reception of the first measurement signal and the second measurement signal.

16. The communication method according to claim 15, wherein when the session with the second communication device is established, both a parameter related to the spatial sensing using the first measurement signal and a parameter related to the spatial sensing using the second measurement signal are transmitted to the second communication device using the control signal.

17. The communication method according to claim 16, wherein when the first measurement signal and the second measurement signal are transmitted to the second communication device, measurement results by the first measurement signal and the second measurement signal are received from the second communication device using the control signal.

18. The communication method according to claim 17, wherein the session with the second communication device is terminated using the control signal after the measurement results are received.

19. A non-transitory storage medium storing a command executable by one or more processors, the command causing the one or more processors to execute the communication method according to claim 10.
